(19) United States
(12) Patent Application Publication
(10) Pub. No.: US 2018/0119468 A1
(43) Pub. Date: May 3, 2018

(54) Control Device for Controlling the Movement of a Corner Cabinet Door of a Corner Cabinet

(71) Applicant: Hetal-Werke Franz Hettich GmbH & Co. KG, Alpirsbach (DE)

(72) Inventor: Horst Abele, Aichhalden (DE)

(21) Appl. No.: 15/792,945

(22) Filed: Oct. 25, 2017

(30) Foreign Application Priority Data
Oct. 28, 2016 (DE) 202016006656.1

(51) Int. Cl. E05D 11/06; A47B 81/00; E05D 15/26; E05D 11/10; E05D 7/086; E05D 5/06; E05F 1/12

(52) U.S. Cl. CPC E05D 11/06; A47B 81/002; E05D 15/264; E05D 11/105; E05Y 2900/132; E05D 5/065; E05F 1/12; E05Y 2900/20; E05D 7/086

(57) ABSTRACT

A control device for controlling the movement of a corner cabinet door of a corner cabinet, wherein the corner cabinet door has a first door element which is mounted on the cabinet carcass in the vicinity of the door opening by means of a door bearing device and a second door element which is mounted swivelably on the first door element via swivel bearing means, with a base part which can be fixed onto the cabinet carcass and a control part which is mounted on the base part so as to be moveable between an inner position and an outer position in which it projects beyond the plane of the door opening, wherein the control part can be coupled with the second door element when closing by means of coupling means and uncoupled when opening, such that it controls the movement of the second door element at the end the closing phase and at the beginning of the opening phase.

### BACKGROUND OF THE INVENTION

The invention relates to a control device for controlling the movement of a corner cabinet door of a corner cabinet which has a cabinet carcass with a door opening, said corner cabinet door being mounted on the cabinet carcass so as to swivel between a closed position in which the door opening is closed and an open position allowing access to an interior space of the cabinet carcass, wherein the corner cabinet door is designed as a folding door, with a first door element which is mounted on the cabinet carcass in the vicinity of the door opening by means of a door bearing device, and with a second door element which is mounted swivelably on the first door element via swivel bearing means.

Corner cabinets with folding doors have long been known. The most common corner cabinets of this type possess a door opening which extends at an angle of 90°, so that in the closed position the two door elements enclose an external angle which amounts to 90°. However, there are also corner cabinet solutions in which the door elements assume an angle other than 90° in the closed position, for example an acute or obtuse angle.

When opening the folding door, as a rule the external angle which the two door elements have assumed relative to one another in the closed position changes. Since in general in order to open the door the user grasps the second door element and pulls this towards them, as a rule the external angle increases when opening the folding door from the angle position assumed in the closed position, for example 90°. If the folding door is then closed again, then as a rule the user again grasps the second, outer door element. However, when swivelling the folding door into the closed position there is a risk that the second, outer door element may strike a cabinet door of an adjacent cabinet or cabinet part and damage the handle thereof or even the front of the cabinet door, if the external angle between the two door elements when swivelling in is greater than the external angle which the two door elements assume relative to one another in the closed position.

Particularly if when closing the two door elements assume an external angle relative to one another which is very large, for example greater than 150°, or even assume a flush alignment relative to one another with the external angle of 180° there is a risk that improper operation may lead to such damage to the adjacent cabinets or cabinet components.

### SUMMARY OF THE INVENTION

The object of the invention is therefore to create a control device for controlling the movement of a corner cabinet door of a corner cabinet in which the risk of damage to cabinets or cabinet components adjacent to the corner cabinet is practically ruled out.

This object is achieved by means of a control device for controlling the movement of a corner cabinet door of a corner cabinet with the features described herein.

The control device according to the invention for controlling the movement of a corner cabinet door of a corner cabinet possesses a base part which can be fixed onto the cabinet carcass and a control part which is mounted on the base part so as to be moveable between an inner position and an outer position in which it projects beyond the plane of a door opening, wherein the control part can be coupled with the second door element by means of coupling means when closing and uncoupled when opening, such that it controls the movement of the second door element at the end of the closing phase and at the beginning of the opening phase.

When closing the corner cabinet door, before it risks striking against a handle or a front of an adjacent cabinet or cabinet part, the second, outer door element first comes into contact with the control part, which projects beyond the plane of the door opening. On further closing of the corner cabinet door, the second door element is coupled with the control part by means of the coupling means, so that the further movement of the second door element into the fully closed position of the corner cabinet door is controlled by means of the control part. The movement of the second door element is also controlled through the control part at the beginning of the opening phase. In conventional folding doors without such a control device, as a rule the user grasps the door handle on the second door element and pulls this towards them. There is thereby a risk that the vertical outer edge of the second door element might come into contact with the facing vertical outer edge of the cabinet door of the adjacent cabinet part or cabinet, as a result of which damage can also be caused both to the second door element of the folding door and also to the cabinet door of the adjacent cabinet part or cabinet when opening the cabinet door. This is prevented through the control of the movement of the second door element by means of the control part at the beginning of the opening phase.

The carcass-side components of the control device, in particular the base part and control part, can be associated with the cabinet base of the corner cabinet. In this case the base part can be mounted in a fixed position on the cabinet base. Alternatively, it is possible for the carcass-side components of the control device to be associated with an upper shelf or intermediate shelf of a corner cabinet. It is possible to use the control device in a corner cabinet serving as a floor unit and/or in a corner cabinet serving as a wall unit and/or in a corner cabinet serving as a tall cabinet unit.

In a further development of the invention, the control part is mounted on the base part so as to be swivelable around a control part swivel axis spaced at a distance from the door swivel axis. In this case, the control part could also be described as a control arm or control lever.

In a further development of the invention, the coupling means comprise a guide groove and a guide pin interacting with this such that, on closing the second door element, the guide pin can be introduced into the guide groove and guided therein as the control part is moved, in particular swivelled, into its inner position, and that when opening the second door element the guide pin is held in the guide groove and guided therein as the control part is moved, in particular swivelled, into its outer position and can be disengaged from the guide groove in the outer position of the control part.

In a particularly preferred manner, the guide groove is formed on the control part and the guide pin is associated with the second door element. Alternatively however, it would also be possible to assign the guide pin to the control part and the guide groove to the second door element, for example through attachment of a component containing the guide groove to the inner side of the second door element.

Particularly preferably, the guide groove has a connecting section open towards an outer side of the control part facing the second door element. This guarantees a simple coupling and uncoupling of guide pin and guide groove, since when closing the door the guide pin is automatically positioned over the mouth section of the guide groove and is able to couple therein.

In a further development of the invention, the guide pin forms part of a coupling element, formed separately from the second door element, associated with the control device, which can in particular be fixed detachably to the inner side of the second door element. Alternatively, as mentioned above, for this purpose the coupling element can also contain the guide groove.

As an alternative to the control part which can swivel around the control part swivel axis, the control part can be designed in the form of a control slider which is mounted on the base part so as to be displaceable in a linear manner between the inner position and the outer position by means of guide means. The guide means can for example comprise a guide track formed on the base part in that a main body of the control part, designed in the manner of a slide carriage, is guided so as to be moveable in a linear manner between the inner and outer position.

In a particularly preferred manner, locking means are provided by means of which the control part is locked in position in its outer position with uncoupled second door element, wherein the locking means are designed such that, on coupling the second door element and control part, a release of the locking takes place enabling a movement of the control part. Expediently, the locking means are designed such that, on opening the folding door and thus moving the control part from its inner position into the outer position, on uncoupling from the second door element a locking of the control part is effected. This guarantees that when opening the folding door the control part is moved out and following uncoupling from the second door element remains in its outer position and also cannot be unintentionally moved back in the direction of its inner position with uncoupled second door element. Alternatively however, it would also be possible for the control part not to be automatically locked on being moved out into its outer position on uncoupling of the second door element, the locking being effected through an operating action on the part of the user.

In a further development of the invention, a stop surface for the second door element, effective in the locked position of the control part, is formed on the control part on its outer side. Expediently, the stop surface is formed on the control part such that when the second door element strikes it no damage, for example scratching, is caused to the inner side of the second door element. In combination with the locking means, which keep the control part locked in the outer position, the stop surface reliably stops the second door element before it can strike the handle or the front of adjacent cabinets or cabinet components.

In a further development of the invention, the locking means have a switching element, guided on the control part so as to be moveable between a locking position assumed in the outer position of the control part with uncoupled second door element and a release position, which can be moved or switched into the release position by introducing the guide pin into the guide groove.

Expediently, the switching element is designed in the form of a switching slider which is adjustable in a linear manner between the locking and release position.

It is possible that the switching element has a locking stop which, in the locking position, is in contact with a counter-stop formed on the base part, causing a blocking of the moveability of the control part.

In a particularly preferred manner, the counter-stop on the base part forms part of a guide contour guiding the locking stop outside of the locking position.

In a further development of the invention, restoring means are associated with the switching element which hold the switching element in the locking position when the second door element is uncoupled. The restoring means can for example comprise at least one spring element, for example in the form of a compression or tension spring.

In a further development of the invention, the switching element has an in particular notch-like engagement opening which, in the locking position of the switching element, aligns with the mouth section of the guide groove allowing engagement of the guide pin.

In a further development of the invention, a damping device, associated in particular with the control part, is provided for the purpose of damping the movement of the control part from the outer to the inner position.

It is possible that the damping device has a rotary damper, said rotary damper preferably having a rotationally-mounted rotary piston which is associated with a gear wheel initiating the rotational movement, and wherein the control part possesses an in particular arc-shaped rack element which meshes with, or can be brought into engagement with the gear wheel.

Expediently, the gear wheel with the rotary piston are arranged on the base part and the rack element is arranged on the control part.

Alternatively, in the case of a control part which is displaceable in a linear manner, it is possible that the damping device has a linear damper with a damper housing and a damper piston mounted therein in a linearly displaceable manner. It is for example possible for the damper housing to be arranged on the control part and for the damper piston to be arranged in a fixed position on the base part.

The invention also comprises a corner cabinet, in particular a kitchen corner cabinet, comprising a cabinet carcass with a door opening and a corner cabinet door which is mounted on the cabinet carcass so as to swivel between a closed position in which the door opening is closed and an open position allowing access to an interior space of the cabinet carcass, wherein the corner cabinet door is designed as a folding door, with a first door element which is mounted on the cabinet carcass in the vicinity of the door opening by means of a door bearing device, and with a second door element which is mounted swivelably on the first door element via swivel bearing means, which is characterised by a control device according to the present disclosure.

It is possible that, in the closed position, outer sides of the two door elements pointing away from the interior space enclose an external angle α which in the closed position lies within the range from 45° to 180° and can be changed when opening the corner cabinet door, wherein a swivel angle limiting device acting between the two door elements is provided through which the swivelling range of the two door elements relative to one another is limited to a maximum external angle alpha which lies within the range from 45° to 180°.

Expediently, the maximum external angle lies within the range from 120° to 130°, in particular amounting to approx. 125°.

### BRIEF DESCRIPTION OF THE DRAWINGS

Preferred exemplary embodiments of the invention are illustrated in the drawing and explained in more detail in the following, wherein:

FIG. 1 shows a perspective representation of a corner cabinet,

FIG. 2 shows a perspective representation of the corner cabinet from

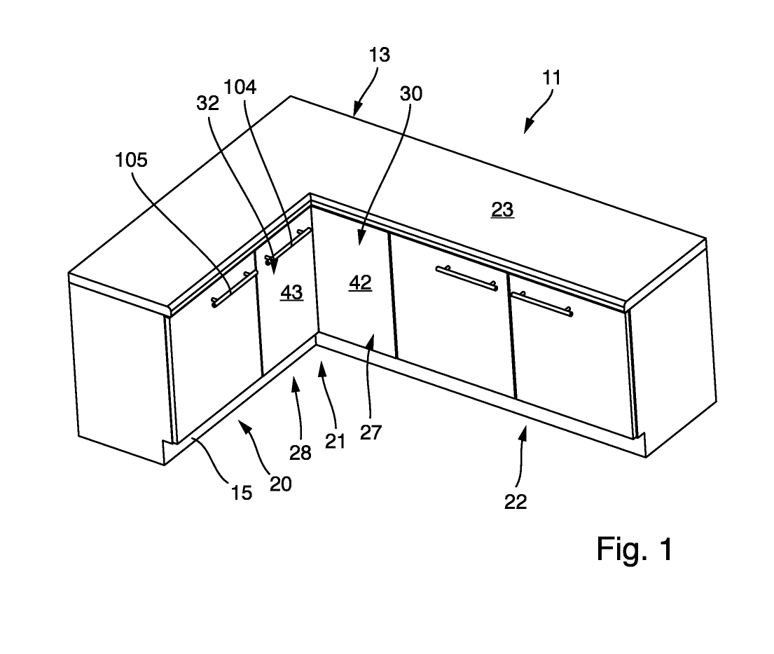

FIG. 1 with opened corner cabinet door, with a first exemplary embodiment of the control device according to the invention,

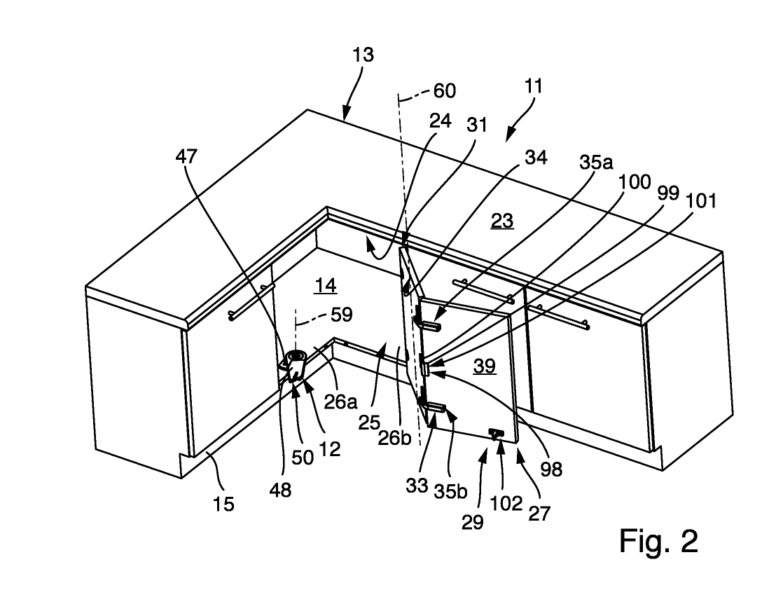

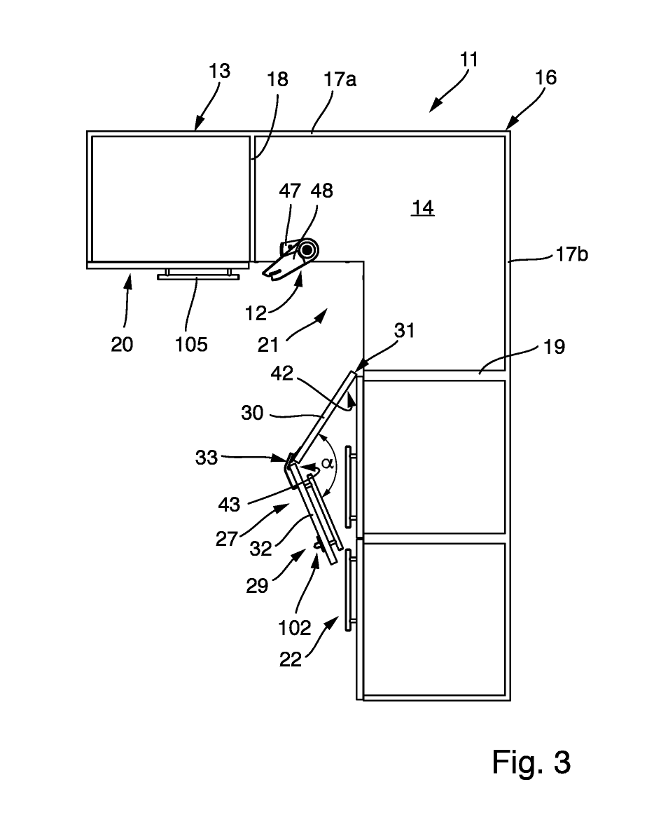

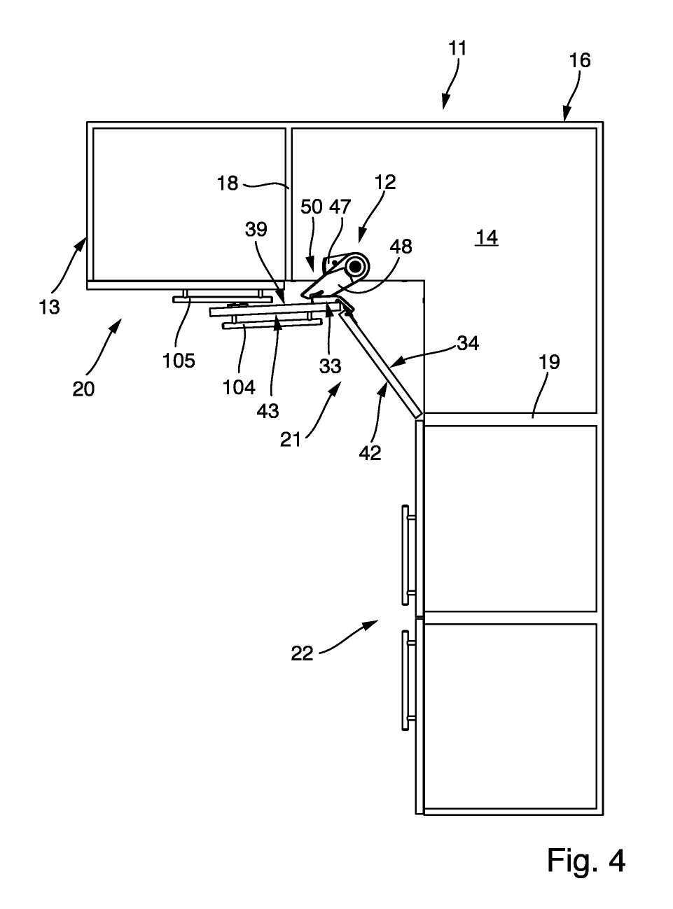

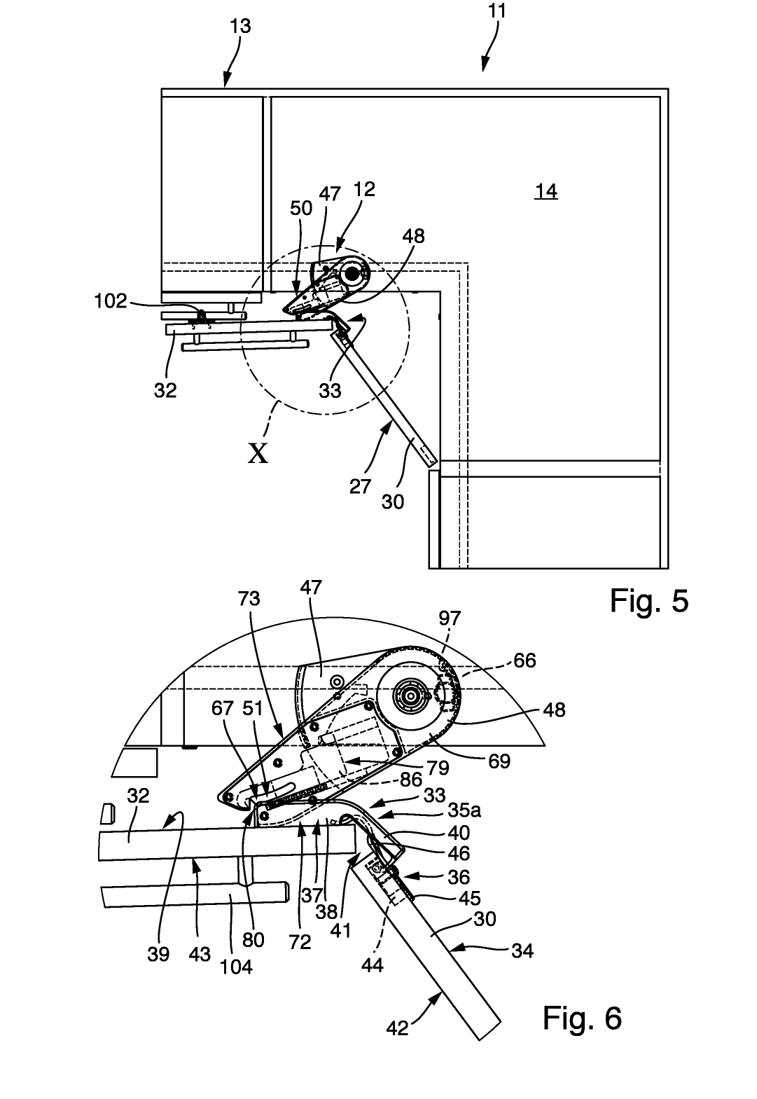

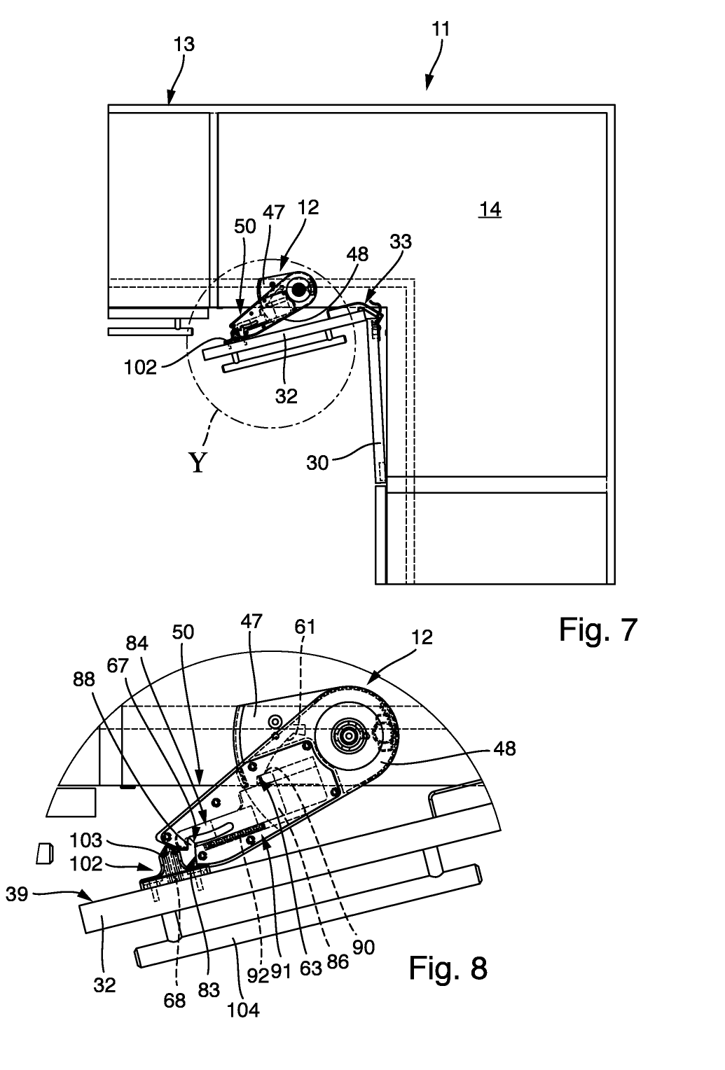

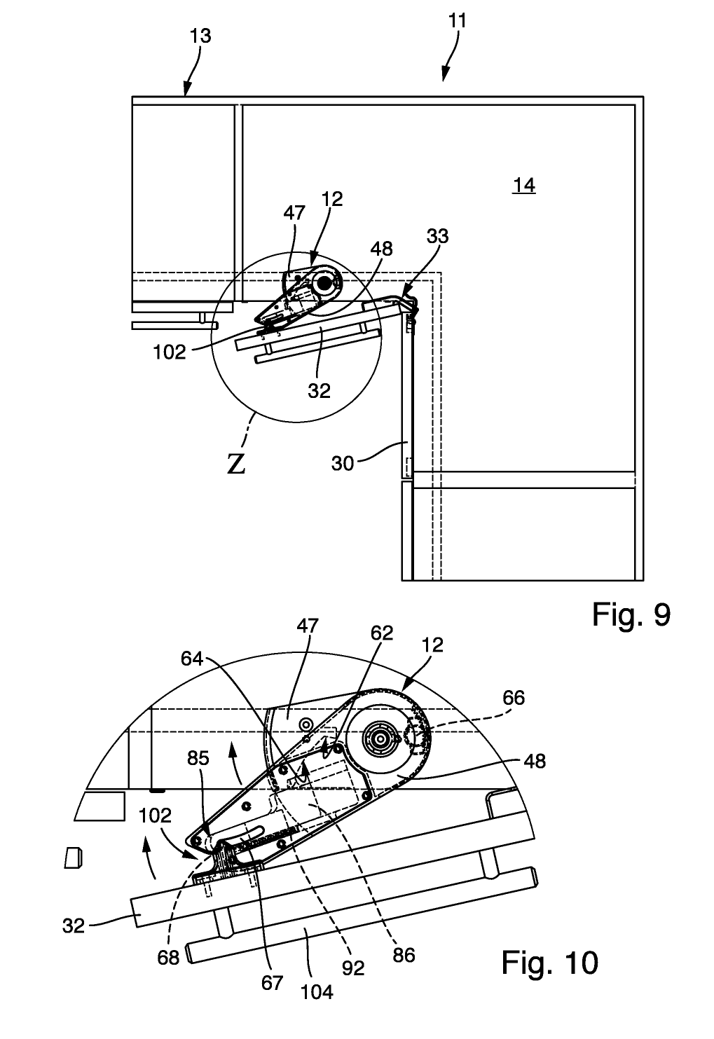

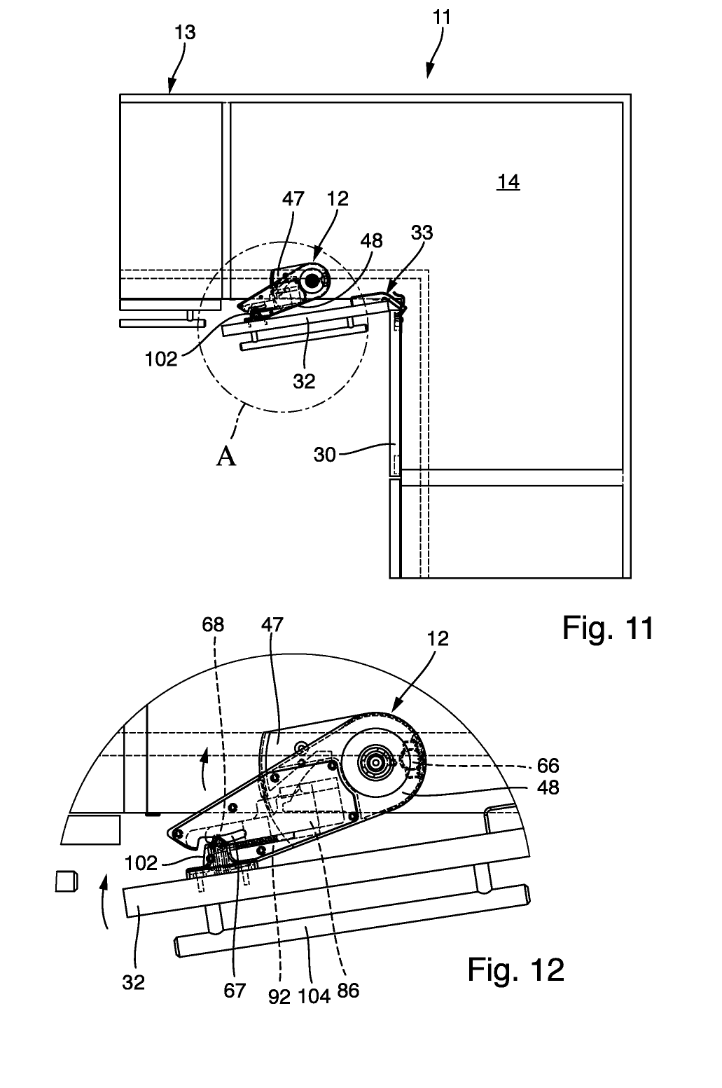

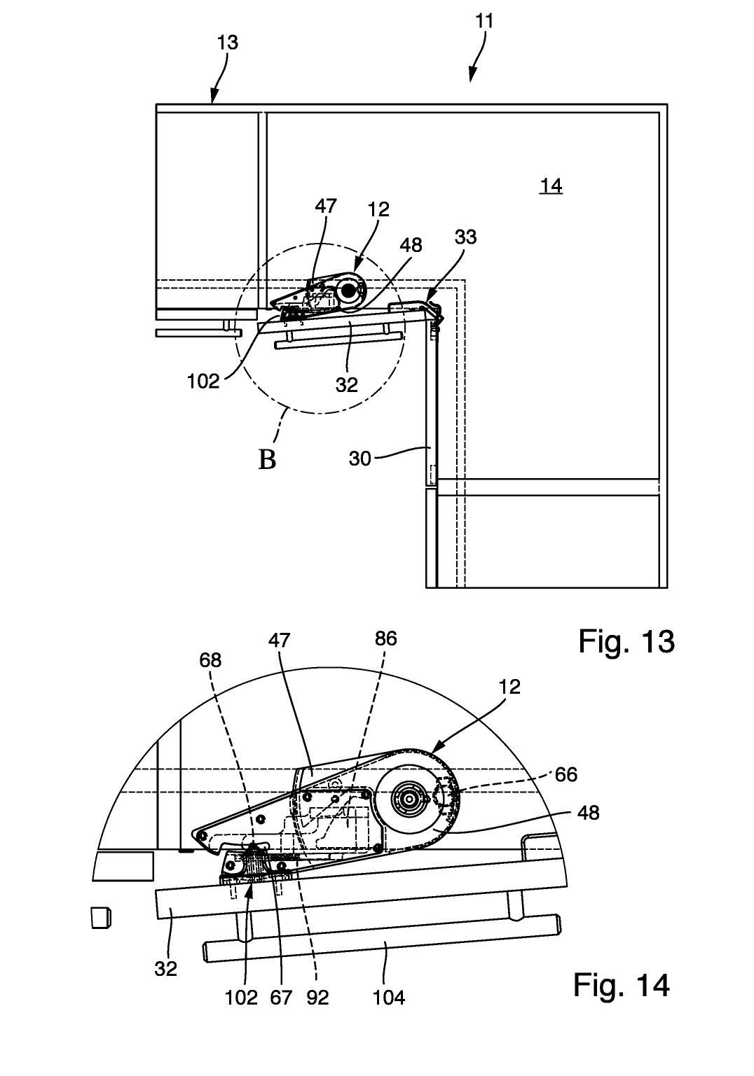

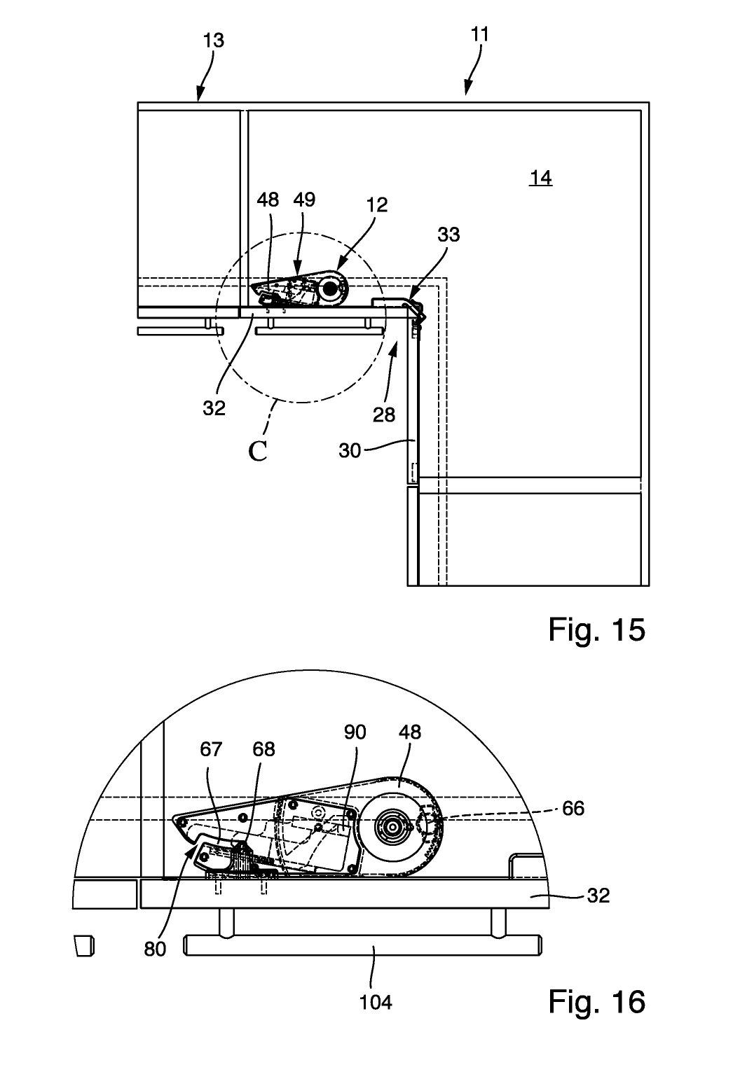

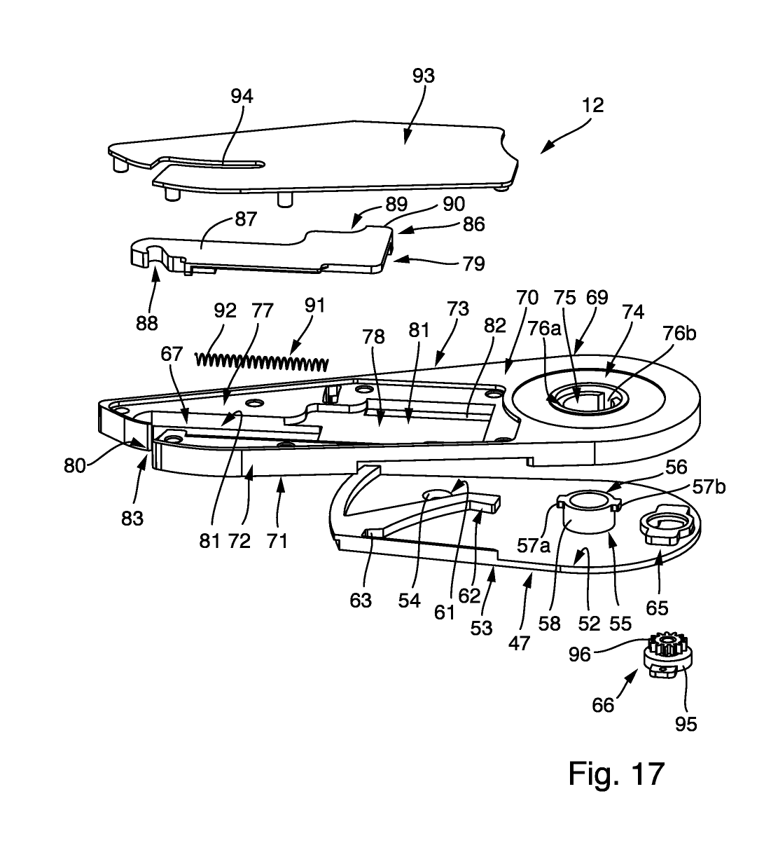

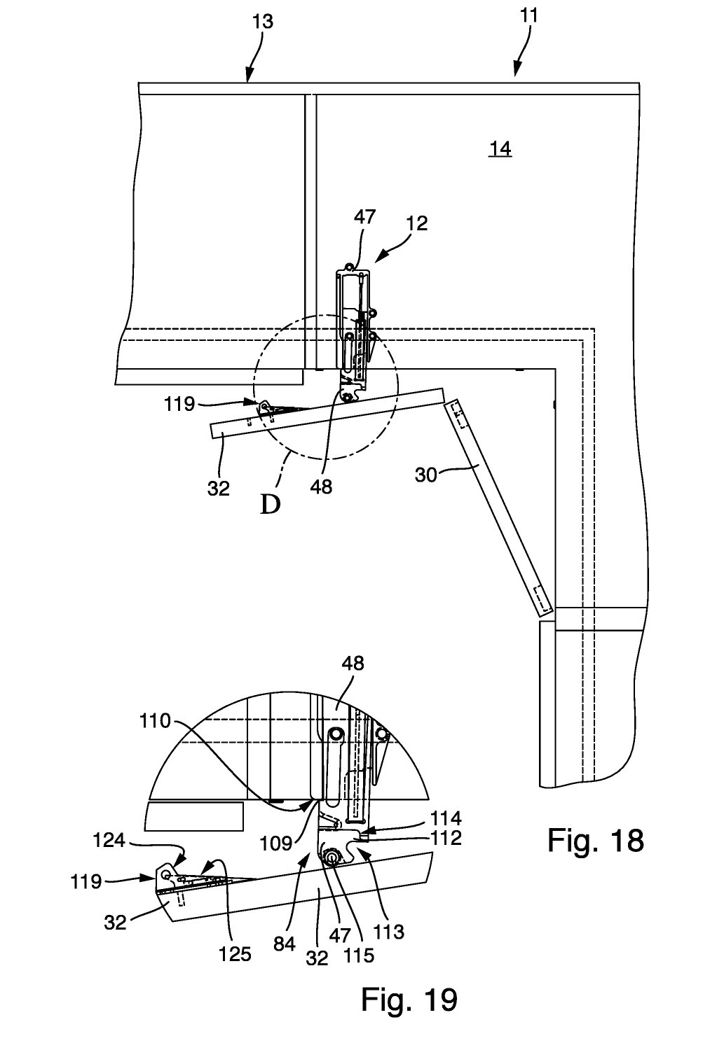

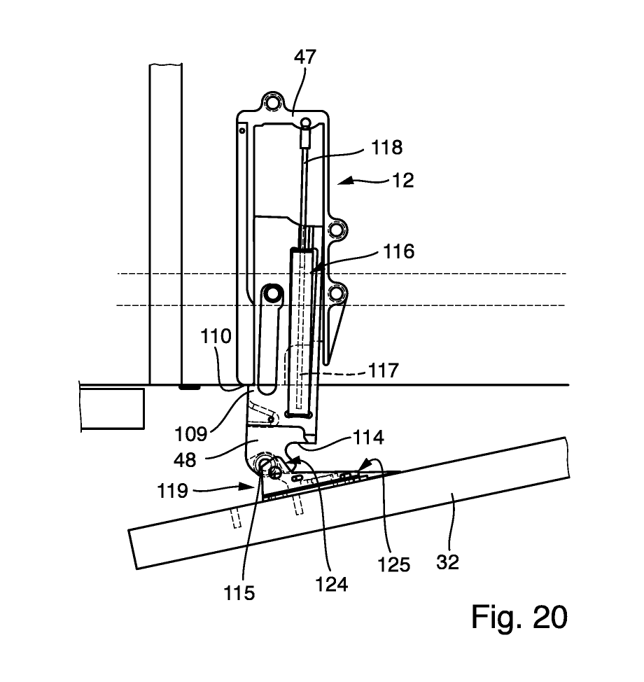

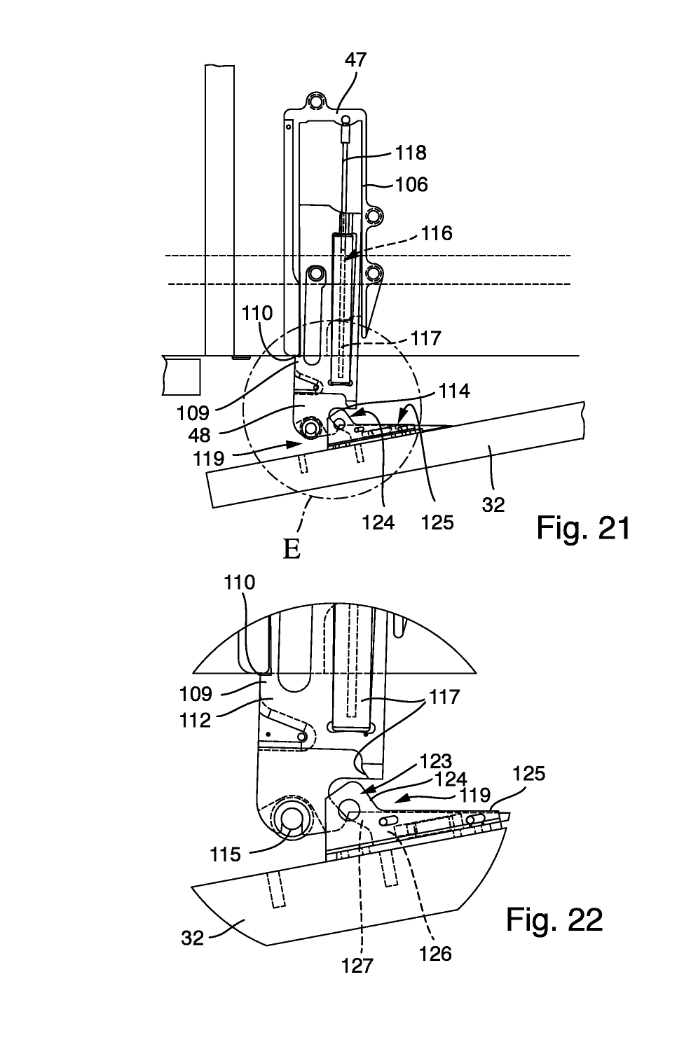

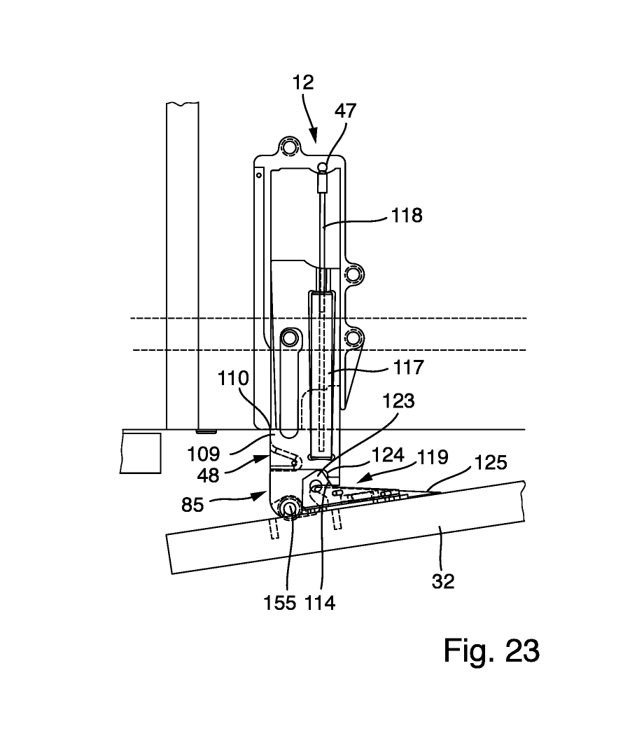

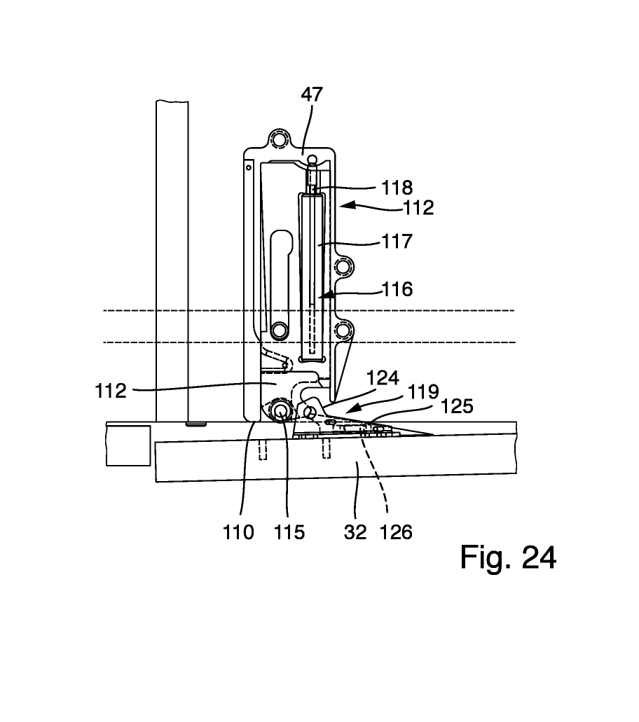

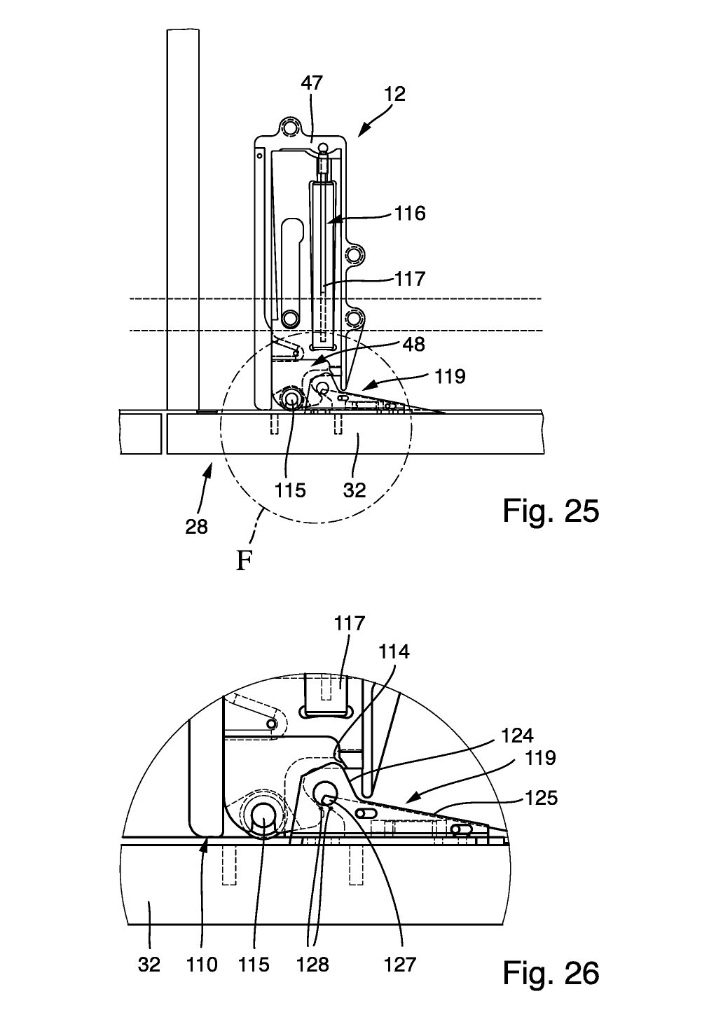

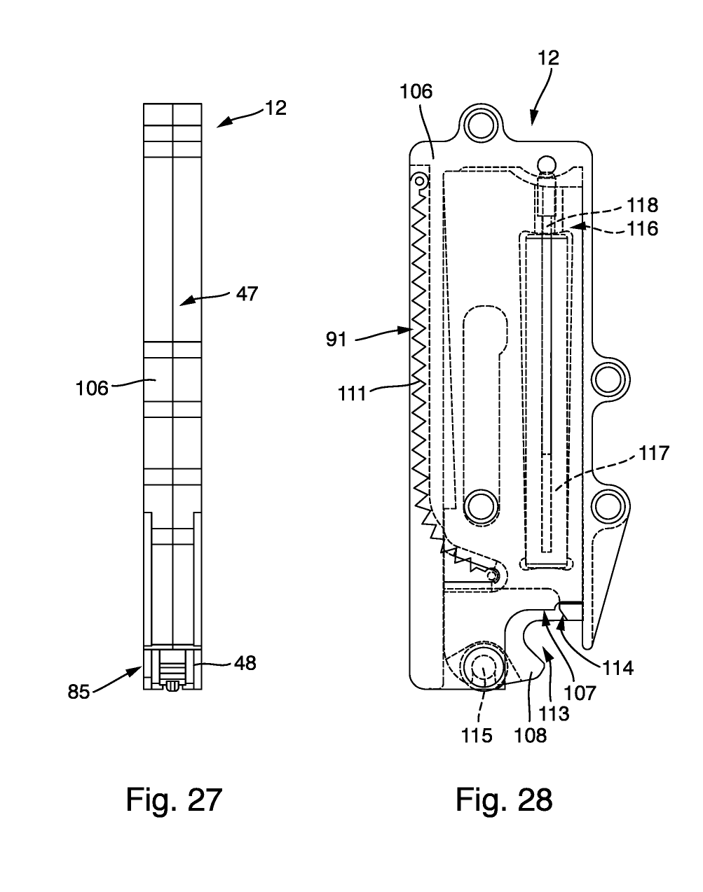

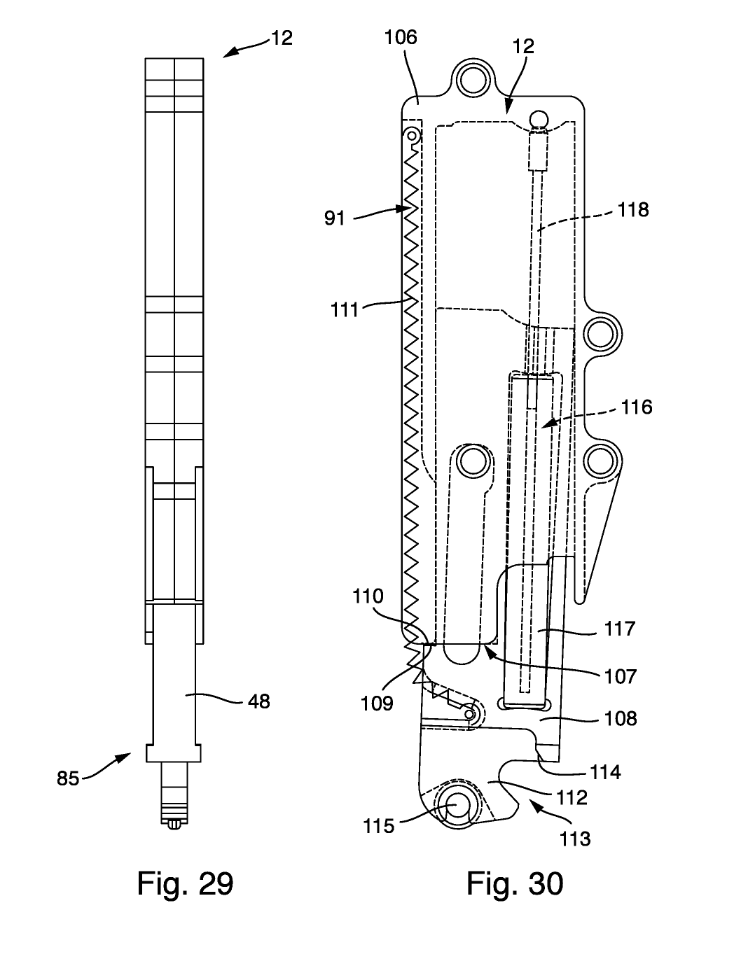

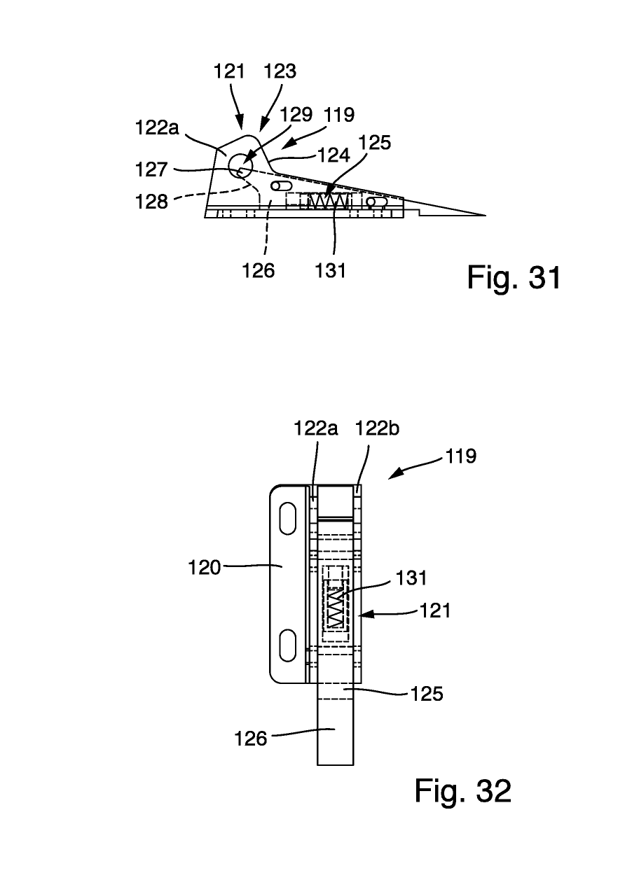

FIG. 3 shows a top view of the corner cabinet from FIG. 2,

FIG. 4 shows a top view of the corner cabinet from FIG. 2, wherein the corner cabinet door is swivelled in the closing direction,

FIG. 5 shows an enlarged representation of the corner cabinet door from FIG. 4 swivelled in the closing direction,

FIG. 6 shows a top view of the corner cabinet from FIG. 5,

FIG. 7 shows a top view of the corner cabinet from FIG. 5, wherein the corner cabinet door is swivelled even further,

FIG. 8 shows an enlarged representation of the detail Y from FIG. 7,

FIG. 9 shows a top view of the corner cabinet from FIG. 5, wherein the corner cabinet door is swivelled even further in the closing direction, the first door element has already assumed its closed position,

FIG. 10 shows an enlarged representation of the detail Z from FIG. 9,

FIG. 11 shows a top view of the corner cabinet from FIG. 5, wherein the corner cabinet door is swivelled further in the closing direction,

FIG. 12 shows an enlarged representation of the detail A from FIG. 11,

FIG. 13 shows a top view of the corner cabinet from FIG. 5,

FIG. 14 shows an enlarged representation of the detail B from FIG. 13,

FIG. 15 shows a top view of the corner cabinet from FIG. 5, wherein the corner cabinet door is in the closed position,

FIG. 16 shows an enlarged representation of the detail C from FIG. 15,

FIG. 17 shows an exploded view of the control part of the first exemplary embodiment of the control device,

FIG. 18 shows a top view of the corner cabinet from FIG. 2, with a second exemplary embodiment of the control device according to the invention, wherein the control part and second door element are uncoupled,

FIG. 19 shows an enlarged representation of the detail D from FIG. 18,

FIG. 20 shows an enlarged representation of the corner cabinet from FIG. 18, wherein the second door element impinges on the control part,

FIG. 21 shows a top view of the corner cabinet from FIG. 18, wherein the second door element is swivelled even further in the closing direction,

FIG. 22 shows an enlarged representation of the detail E from FIG. 21,

FIG. 23 shows a top view of the corner cabinet from FIG. 18, wherein the second door element is coupled to the control device,

FIG. 24 shows a top view of the corner cabinet from FIG. 18, wherein the corner cabinet door is swivelled further in the closing direction and the movement of the second door element is effected by means of the control part,

FIG. 25 shows a top view of the corner cabinet from FIG. 18, wherein the second door element assumes its closed position and the corner cabinet door is in the closed position,

FIG. 26 shows an enlarged representation of the detail F from FIG. 25,

FIG. 27 shows a side view of the base part and control part of the second exemplary embodiment of the control device,

FIG. 28 shows a top view of the base part and control part from FIG. 27, wherein the control part is in the inner position,

FIG. 29 shows a side view of the base part and control part according to FIG. 27, wherein the control part is in its outer position,

FIG. 30 shows a top view of base part and control part of the second exemplary embodiment of the control device, wherein the control part is in its outer position,

FIG. 31 shows a side view of a coupling element of the second exemplary embodiment of the control device according to the invention which is to be fixed to the inner side of the second door element and

FIG. 32 shows a top view of the coupling element from FIG. 31.

### DETAILED DESCRIPTION

FIGS. 1 to 17 show a first exemplary embodiment of the control device 12 according to the invention installed in a corner cabinet 11.

As shown in FIG. 3 in particular, the corner cabinet 11 has a cabinet carcass 13, which by way of example is shown with an L-shaped floor outline. The cabinet carcass 13 consists of a cabinet base 14, which by way of example is also equipped with an L-shaped floor outline. As a rule, supporting feet are arranged on the underside of the cabinet base 14 which are if necessary height-adjustable in order to guarantee that the corner cabinet 11 stands without any play, even on an uneven floor surface. The intervening space between the underside of the cabinet base 14 and the floor surface within which the supporting feet are arranged is clad with a baseboard 15. The cabinet carcass 14 also possesses a rear wall 16 which for example consists of two rear wall parts 17a, 17b arranged at right angles relative to one another. As shown in FIG. 3 in particular, the two rear wall parts 17a, 17b, preferably adjoin side walls 18, 19 arranged at right angles thereto.

At the same time the side walls 18, 19 form side walls for left-hand and right-hand extensions of the cabinet carcass 13. In the example shown, a carcass component 20 with rectangular floor outline adjoins the carcass component of the cabinet carcass 13 with L-shaped floor outline on the left-hand side. At the same time the left-hand side wall 18 of the L-shaped carcass component, referred to in the following as the inner carcass component 21, forms the right-hand side wall of the further carcass component 20. A further carcass component 22 also adjoins the right-hand side wall 19 of the inner L-shaped carcass component 21 of the corner cabinet 11, so that the right-hand side wall 19 forms the left-hand side wall of the further carcass component 22.

In the example shown, the right-hand further carcass component 22 is twice as large as the left-hand further carcass component 20. Naturally it is also possible for the dimensions of the further carcass components 20, 22 to be quite different. For example, the left-hand carcass component could be larger than the right-hand one. It is also possible that the inner carcass component 20 with L-shaped floor outline forms the complete corner cabinet 11 and in this case further separate cabinets, in particular in the form of floor units, adjoin it on the left-hand and right-hand sides.

The corner cabinet 11 also possesses an upper cabinet covering, which by way of example is shown in the form of a work surface 23. As shown in FIG. 1 in particular, the work surface 23 is also L-shaped in form and extends over all the carcass components 20 to 22 of the corner cabinet 11.

As shown in FIG. 2 in particular, in relation to the inner carcass component 20, the L-shaped cabinet base 14, the two side walls 18, 19, the two rear wall parts 17a, 17b and the L-shaped section of the work surface 23 above the inner carcass component 21 delimit an interior space 24. As also shown in FIG. 2, the outer edges of the side walls 18, 19, the outer edges of the L-shaped cabinet base 14 and lower edges of the L-shaped section of the work surface 23 delimit a door opening 25 which in the example shown has two opening sections 26a, 26b arranged at right angles relative to one another.

The inner carcass component 21 is also associated with a corner cabinet door 27 which is mounted on the cabinet carcass 13 so as to swivel between a closed position 28 in which the door opening 25 is closed (FIG. 1) and an open position 29 which allows access to the interior space 24 of the cabinet carcass 13 (FIG. 2).

The corner cabinet door 27 is designed as a folding door, with a first door element 30 which is mounted on the cabinet carcass 13 in the vicinity of the door opening 25 by means of a door bearing device 31 and with a second door element 32 which is mounted swivelably on the first door element 30 via swivel bearing means 33. The door bearing device 31 by means of which the first door element 30 is swivelably mounted is located in the region of the right-hand opening section 26a and in the region of the right-hand side wall 19. The door bearing device 31 comprises two hinges (not shown) which are fixed, on the one hand, to the side of the side wall 19 facing the interior space 24 and on the other hand to the inner side 34 of the first door element 30.

The second door element 32 is, as mentioned, mounted swivelably on the first door element 30 via swivel bearing means 33. In the example shown, as shown in FIGS. 2 and 6 in particular, the swivel bearing means 33 comprise at least one hinge 35 connecting the two door elements 30, 32 swivelably with one another, in particular two hinges 35a, 35b, of which a first hinge 35a is arranged in the upper region of the two door elements 30, 32 and a second hinge 35b is arranged in the lower region of the two door elements 30, 32. The hinges 35a, 35b each possess a first hinge part 36 fixed on the first door element 30 and a second hinge part 37 fixed on the second door element 32 which are connected with one another in an articulated manner via at least one articulated joint. In the example shown, the two hinge parts 36, 37 are designed in the form of a hinge cup and a hinge arm, wherein, as shown in FIG. 2 in particular, according to a first exemplary embodiment the hinge cup is fixed to the first door element 30 and the hinge arm is fixed to the second door element 32.

As shown in FIG. 6 in particular, the hinge arm associated with the second door element 32 possesses a fixing section 38, which is fixed onto the inner side 39 of the second door element 32. Connected in a single piece with the fixing section 38, an arm section 40 is provided which bridges a joint 41 between the two door elements 30, 32 and points in the direction of the hinge cup. The arm section 40 projects at an angle from the associated fixing section 38 and is oriented at an angle in the direction of outer sides 42, 43 of the two door elements 30, 32.

As also shown in FIG. 6, the hinge cup possesses a cup section 44 which is fitted in a cup-like recess in the inner side 39 of the first door element 30. In addition to the cup section 44 the hinge cup also possesses a mounting plate 45 for mounting on the inner side 34 of the first door element 30. The mounting plate 45 possesses for example two mounting holes via which fixing screws can be screwed into the material of the first door element 30. The cup section 44 of the hinge cup possesses a cup opening (not shown) bounded by a cup wall (not shown) which is limited on the underside by a cup bottom. A lever 46 connecting a hinge cup and hinge arm with one another is provided which on the one hand is mounted in an articulated manner on the hinge cup and on the other hand is mounted in an articulated manner on the hinge arm, in particular on its arm section 40.

As shown in FIGS. 2 to 17 in particular, a control device 12 for controlling the movement of the corner cabinet door 27 is associated with the corner cabinet 11.

The control device 12 possesses a base part 47 fixed to the cabinet carcass 13 and a control part 48 which is mounted on the base part 47 so as to be moveable between an inner position 49 and an outer position 50 in which it projects beyond the plane of the door opening 25.

The control part 48 is equipped with coupling means 51 by means of which the control part 48 can be coupled with the second door element 32 when closing and uncoupled when opening, such that it controls the movement of the second door element 32 at the end of the closing phase and at the beginning of the opening phase. Expediently, the base part 47 and control part 48 of the control device 12 consist io of plastic material, but can, alternatively, also consist of metal material.

As shown in FIGS. 2 and 17 in particular, the base part 47 is designed in the form of a plate and possesses a upper side 52 of the base part and a base part underside 53 opposite this.

As shown in FIG. 6 in particular, the base part 47 is fixed on the cabinet base 14 in the vicinity of the door opening 25, specifically in its left-hand opening section 26a.

The base part underside 53 thereby lies on the upper side of the cabinet base 14. The base part 47 possesses several mounting holes 54 through which fixing screws can be passed in order to fix it onto the cabinet base 14. The upper side 52 of the base part 47 is characteristic in design and possesses several functional sections which differ from one another. One of these functional sections forms part of a coupling 55 for coupling the base part 47 and control part 48. The coupling 55 can for example be designed in the form of a bayonet coupling. In the example shown, a cylindrical connecting piece 56 is arranged on the upper side 52 of the base part which projects upwards from the upper side 52 of the base part. In particular two noses 57a, 57b are formed, diametrically opposite one another, on the free end of the cylindrical connecting piece 56. The two noses 57a, 57b extend radially outwards beyond the barrel section 58 of the connecting piece 56. However, the noses 57a, 57b do not extend over the entire height of the connecting piece 56, so that the lower part of the barrel section 58 is free of the noses 57a, 57b. The longitudinal axis running through the connecting piece 56 also represents an arm swivel axis 59 for the control part 48 mounted swivelably on the base part 47 according to a first exemplary embodiment. The arm swivel axis 59 lies at a distance from a door swivel axis 60, which lies within the region of the door bearing device 31. The connecting piece 56 on the upper side 52 of the base part interacts with a corresponding component on the control part 48, which will be described in more detail in the following.

A further functional section on the upper side 52 of the base part comprises a guide contour 61 which is raised above the upper side 52 of the base part. The guide contour 61 can for example also be created during manufacture of the base part 47. The guide contour 61 possesses a sloping surface 64 formed between two stops 62, 63 in order to adjust a component formed on the control part 48, which will also be described in more detail in the following.

Finally, a third functional section is formed on the upper side 52 of the base part which comprises a mounting section 65 projecting upwards from the upper side 52 of the base part for the purpose of mounting a rotary damper 66 which will be described in more detail in the following.

As shown in FIG. 17 in particular, the control part 48 according to the first exemplary embodiment is designed in the form of a multiple-part component. The control part 48 comprises components of the coupling means 51 for coupling it with the second door element 32. The coupling means 51 comprise a guide groove 67 and a guide pin 68 interacting with this such that when closing the second door element 32 the guide pin 68 enters the guide groove 67 and is guided therein during swivelling of the control part 48 as far as its inner position 49, and that when opening the second door element 32 the guide pin 68 is held within the guide groove 67 and is guided therein during swivelling of the control part 48 as far as its outer position 50 and moves out of the guide groove 67 in the outer position 50 of the control part 48.

As shown in FIG. 6 in particular, in the example shown the guide groove 67 is formed on the control part 48, while the guide pin 68 is associated with the second door element 32.

As shown in FIG. 17 in particular, the control part 48 possesses a main body 69 which is designed in the form of a type of swivel arm or swivel wing. The main body 69 is relatively flat, i.e. plate-like in form, and possesses a main body upper side 70 and a main body underside 71 opposite this. The main body 69 also possesses a barrel section 58 which possesses an outer side 72 pointing towards the second door element 32 and an inner side pointing towards the interior space 24. The main body 69 can also be divided into several functional sections, of which a bearing section 74 serves as a pivot bearing on the base part 47.

The bearing section 74 on the main body 69 of the control part 48 comprises a substantially cylindrical recess 75, passing through the main body 69 in a vertical direction, from which two grooves 76a, 76b, in particular arranged diametrically opposite one another, extend radially outwards from the cylindrical part of the recess 75. The cylindrical recess 75 with the two grooves 76a, 76b also forms part of the coupling 55, in particular a bayonet coupling, wherein in order to couple the control part 48 with the base part 47 grooves 76a, 76b and noses 57a, 57b on the connecting piece 56 of the base part 47 are aligned flush with one another so that the main body 69 of the control part 48 can be plugged onto the connecting piece 56. The grooves 76a, 76b thereby pass the noses 57a, 57b and come to lie below these, as a result of which the whole opening section of the cylindrical recess 75 is arranged, without any blocking, below the two noses 57a, 57b, as a result of which a rotational moveability of the control part 48 in relation to the base part 47 is made possible.

An important functional section of the main body 69 of the control part 48 is a coupling section 77 which, as shown in FIG. 17 in particular, possesses a window-like depression 78 moulded into the main body upper side 70. The window-like depression 78 forms part of locking means 79 by means of which the control part 48 is locked in position in its outer position 50 with uncoupled second door element 32, wherein the locking means 79 are designed such that on coupling the second door element 32 and control part 48 a release of the locking takes place enabling swivelling of the control part 48.

On the bottom of the window-like depression 78 there are two openings which pass through the rest of the main body 69, one of which is the guide groove 67. The guide groove 67 is thus provided on the underside 71 of the main body. The guide groove 67 possesses a mouth section 80 open towards the outer side 72 of the main body 69 and a guide section 81 following on from this. The guide section 81 of the guide groove 67 is curved in form and extends from the mouth section 80 in the direction of the arm swivel axis 59. The mouth section 80, in contrast, runs at an angle to the guide section 81. On the bottom of the window-like depression 78 there is also an elongated slot 82 for guiding a component which will be described in more detail in the following.

As shown in FIG. 17 in particular, the main body 69 possesses a frontal stop 83 in extension of the mouth section 80. The frontal stop 83 is formed in that the outer side 72 of the main body 69 springs back towards the tip of the main body 69.

The locking means 79 have a switching element 86 which, in the outer position 50 of the control part 48 with uncoupled second door element 32, is guided on the control part 48 so as to be moveable between a locking position 84 and a release position 85, which can be moved into the release position 85 by introducing the guide pin 68 into the guide groove 67.

As shown in FIG. 17 in particular, the switching element 86 is designed in the form of a switching slider and is guided so as to be moveable in a linear manner between the locking position 84 and the release position 85 through lateral walls of the window-like depression 78, which form a sort of guide track for the switching element 86. The switching slider is characteristic in form and possesses a coupling section 87 which is finger-like in form and has at its free end a notch-like engagement opening 88 which in the locking position 84 of the switching slider aligns with the mouth section 80 of the guide groove 67.

As shown in FIG. 17 in particular, in addition to the finger-like coupling section 87 the switching slider or switching element 86 possesses a locking section 89, expediently with a larger cross section in comparison with the coupling section 87. On the underside of the switching slider within the region of the locking section 89 there is a locking stop 90 which, in the locking position 84, 47 is in contact with a counter-stop 63 formed on the base part, causing a blocking of the swivelability of the control part 48. In the example shown, the locking stop 90 is formed by a projection projecting downwards from the underside of the switching slider, while the counter-stop 63 is formed by one of the two stops 62, 63 of the guide contour 61 on the base part 47. In the example described, the counter-stop 63 is formed by the lower stop of the guide contour 61.

Associated with the switching element 86 are restoring means 91 which hold the switching element 86 in the locking position 84 when the second door element 32 is uncoupled. In the example shown, the restoring means 91 comprise a spring element 92, in particular in the form of a compression spring, which is mounted on the main body 69 in a spring support within the region of the window-like depression 78 and is supported on the one hand on a projection formed on the main body 69 and on the other hand on a projection formed on the switching element 86.

As shown in FIG. 17 in particular, the control part also comprises a cover 93 which covers the region of the window-like depression 78 and thus secures the switching slider against falling out. A guide channel 94, replicating the form of the guide groove 67 and corresponding with the guide groove 67, is formed in the cover. The cover 93 can be fastened onto the main body 69 by means of suitable fastening means.

As also shown in FIG. 17, and described above, a damping device in the form of a rotary damper 66 is provided for the purpose of damping the swivel movement of the control part 48 from the outer to the inner position 50, 49. The rotary damper possesses a rotationally-mounted rotary piston (not shown) which is arranged within a damper housing 95 which is in turn fixed on the mounting section 65 of the base part. The rotary piston is associated with a gear wheel 96 initiating the rotational movement which projects upwards from the cylindrical opening of the mounting sections 65. An arc-shaped rack element 97 which meshes with the gear wheel 96 is also provided on the main body 69 of the control part 48.

A swivel angle limiting device 98 acting between the two door elements 30, 32 is also provided, by means of which the swivelling range of the two door elements 30, 32 relative to one another is limited to a maximum external angle α which lies within the range from 45° to 180°. Expediently, the maximum external angle amounts to approx. 125°.

In the example shown, the two opening sections 26a, 26b of the door opening 25 are oriented at an angle of 90° relative to one another. Therefore, in the closed position 28 the two door elements 30, 32 assume an external angle α which amounts to 90°.

In the example shown, the swivel angle limiting device 98 is formed separately from the swivel bearing means, i.e. the hinges 35a, 35b. The swivel angle limiting device 98 comprises at least one angle piece 99 which has an in particular plate-like mounting section 100 by means of which the angle piece 99 is fixed to the inner side 34 of the first door element 30.

The angle piece 99 also possesses a stop section 101 which is in particular formed in a single piece with the mounting section 100 and projects from this at an angle. The stop section 101 serves as a stop for the second door element 32 and bridges the joint 41 between the two door elements 30, 32, wherein the free end terminates with a stop surface (not shown) within the region of the inner side 39 of the second door element 32.

As shown in FIG. 2 in particular, the angle piece 99 is located approximately in the centre between the two hinges 35a, 35b. The angle piece 99 is a relatively economical retrofit component, so that corner cabinet doors 26 equipped with conventional hinges can be retrofitted with a swivel angle limiting device 98.

As shown in FIG. 8 in particular, the control device 12 also comprises a coupling element 102 which is fixed to the inner side 39 of the second door element 32. The coupling element 102 comprises a mounting plate for mounting on the inner side 39 of the second door element 32. Projecting roughly at right angles from the mounting plate is a pin support 103, on the underside of which the guide pin 68 is formed, in particular being connected integrally with the pin support 103.

The corner cabinet door 26 is initially in the closed position 28 illustrated in FIG. 1. The outer sides 42, 43 of the two door elements 30, 32 thereby enclose an external angle α which amounts to 90°. In order to open the corner cabinet door 27, the user grasps the door handle 104 formed on the second door element 32 and pulls the second door element 32 in their direction. The whole corner cabinet door 27 thereby swivels around the door swivel axis 60. At the beginning of the opening phase, as described in more detail below, the second door element 32 is controlled by the control device 12, as a result of which the control part 48 swings out of the plane of the door opening 25. After a certain opening travel, the control part 48 and second door element 32 are uncoupled. The corner cabinet door 26 can now be swivelled open further, wherein the external angle α assumed in the inner position is variable.

As shown in FIG. 2 in particular, the swivel angle limiting device 98 prevents the second door element 32 from being able to swivel around the first door element 30 within a large angular range. In the example shown, the maximum external angle is limited to approx. 125°. Thus, if the external angle α is increased when opening the door, this is only possible up to approx. 125°. Once this angle is reached, the inner side 39 of the second door element 32 impinges against the stop surface on the stop section 101 of the angle piece 99. This situation is shown, by way of example, in FIG. 2.

When closing the corner cabinet door 26, the whole corner cabinet door 26 initially swivels inwards around the door swivel axis 60.

As shown in FIGS. 5 and 6 in particular, the inner side 39 of the second door element 32 initially comes into contact with the control part, which is in the locked outer position 50. The inner side 39 of the second door element 32 impinges against the stop surface on the outer side 72 of the main body 69. In combination with the swivel angle limiting device 98, this prevents the second door element 32 from striking against a door handle 105 of an adjacent cabinet part or cabinet, for example of the left-hand carcass component 20 or even the door front. The orientation of the second door element 32 is roughly parallel to the door of the adjacent carcass component 20 on the left.

On further closing of the corner cabinet door 27, as illustrated in FIGS. 7 to 10, the first door element 30 first swivels fully into its closed position, before the coupling element 102 fixed to the inner side 39 of the second door element 32 comes into contact with the control part 48.

As shown in FIG. 10 in particular, the guide pin initially impinges against the frontal stop 83 on the outer side of the main body 69 of the control part 48 and as a result is guided to the mouth section 80 of the guide groove 67. The switching slider or switching element 86 of the locking means 79 is in its locking position 84, wherein the compression spring presses the switching slider in the direction of the mouth section 80, so that the notch-like engagement opening 88 is aligned with the mouth section 80 of the guide groove 67.

In the locking position 84 of the switching slider, the locking stop 90 of the locking section 89 of the switching slider is in contact with the counter-stop 63 on the guide contour 61 on the base part 47. This situation is for example shown in FIG. 8.

As the guide pin is moved into the mouth section 80 of the guide groove 67, this is at the same time threaded into the notch-like engagement opening 88. On further movement, i.e. closing movement of the second door element 32, the switching slider is moved, against the spring force of the compression spring, from its locking position 84 in the direction of its release position 85, whereby the locking stop 90 of the switching slider and the counter-stop 63 on the guide contour 61 of the base part 47 become disengaged. In this situation it is possible for the control part 48 to swivel from the outer position in the direction of the inner position.

Following the coupling of the control part 48 and the second door element 32, i.e. of the guide pin 68 and guide groove 67, the further closing movement of the second door element 32 is controlled by the control part 48.

The rotary damper 66 is provided in order to damp the movement of the second door element 32 into the closed position 28. On further closing movement of the second door element 32, the arc-like rack element 97 on the main control body 69 of the control part 48 is moved past the gear wheel 96, which is fixed in position but mounted so as to rotate, whereby this movement is transferred to the rotary piston which provides a damping effect.

In the closed position of the corner cabinet door 27 shown in FIGS. 15 and 16, the control part 48 is also in its 15 inner position 49. The guide pin 68 and guide groove 67 remain coupled. The switching slider is in its release position 85. On subsequent opening of the corner cabinet door 26, the control part 48 is thus swivelled out again, wherein the control part 48 prevents 20 the second door element 32 from being pulled in the direction of the cabinet door of the adjacent carcass component 20, preventing damage to the edges of the doors facing one another.

FIGS. 18 to 32 show a second exemplary embodiment 2 of the control device 12 according to the invention

In contrast to the first exemplary embodiment described above, the control part 48 is designed in the form of a control slider which is guided on the base part 47 30 so as to be displaceable in a linear manner between the inner position 49 and the outer position 50 by means of guide means.

As shown in FIGS. 18 and 20 in particular, the base part 47 is fixed within the region of the door opening 25, specifically in the left-hand opening section 26a, by means of suitable fastening means.

As shown in FIG. 30 in particular, the base part 47 possesses a main body 106 which is composed of two parts, in particular half-shells, and possesses a receiving opening 107 for the control part 48 which is mounted displaceably therein.

As shown in FIG. 30 in particular, the control slider designed in the form of a control part 48 possesses a base section 108 which is guided, so as to be displaceable in a linear manner, in the receiving opening 107 of the main body 106 of the base part 47.

Locking means 79 are again provided which, according to the second exemplary embodiment, comprise a catch 109 formed on the base section 108 on its longitudinal side. In the example shown, the catch 109 is formed as a step in the form of a narrowing of the cross section of the base section 108. In the locking position of the control part 48, the catch 109 lies against a ratchet surface 110 on a wall of the main body 106 surrounding the receiving opening 107. Restoring means 91 are again provided which ensure that the control slider is locked in its extended outer position 50. The restoring means 91 comprise a spring element 111, which in this example is in the form of a tension spring which is mounted on the one hand on the base section 108 of the control slider and on the other hand on the main body 106. The catch 109 is pressed against the ratchet surface 110 by the spring element 111.

In addition to the base section 108, the control slider also comprises a coupling section 112 which is located on the free end of the base section 108 and projects from the receiving opening 107 in the outer position 50 of the control slider. The coupling section 112 has a reduced thickness in comparison with the base section 108. A notch-like engagement opening 113 is formed on the coupling section 112. In addition, a release bevel 114 is formed at the transition between the coupling section 112 and base section 108. The coupling section 112 also has a rotatably mounted roller 115 at its free end. In addition, a damping device in the form of a linear damper 116 is installed between the base part 47 and the base section 108 of the control slider or control part 48. The linear damper 116 possesses a damper housing 117 which is mounted on the base section 108 and a damper piston (not shown), which is guided in a linearly displaceable manner within the damper housing 117. The damper piston sits on a piston rod 118 which is in turn mounted in a fixed position on the base part 47.

The second door element 32 is associated with a coupling element 119 for coupling with the control part 48. The coupling element 119 is fixed on the inner side 39 of the second door element 32, in particular by means of a mounting plate 120. The coupling element 119 possesses a leg-like coupling section 121, with two legs 122a, 122b arranged parallel to one another. The legs 122a, 122b each possess a head region 123 which slopes down towards the front side and, on the rear side, an unlocking bevel 124 on each of the two legs 122a, 122b. The unlocking bevel 124 on the two legs 122a, 122b transitions into a ramp 125 which is inclined less steeply in comparison with the unlocking bevel 124. Between the two legs 122a, 122b there is a moveable part 126, the tip 127 of which projects into the head region 123 of the legs 122a, 122b. A withdrawal surface 128 is formed on the underside of the tip 127. The moveable part 126 is guided so as to move between a coupling position 129 and a release position 130, wherein a spring element 131 presses the moveable part 126 into the coupling position 129, wherein the spring element 131 is supported on the one hand on the coupling section 121 and on the other hand on the moveable part 126 and is, expediently, in the form of a compression spring.

As shown in FIGS. 18 and 19 in particular, when closing the corner cabinet door 27, the inner side 39 of the second door element 32 first comes into contact with the coupling section 112 of the control slider which is in the locked outer position 50. The roller 115 thereby lies against the inner side 39 of the second door element 32. On further closing the corner cabinet door 27, the ramp 129 runs past the roller 115, wherein the narrow coupling section 112 slides through between the two legs 122a, 122b, arranged parallel to one another, of the coupling element 119 on the inner side 39 of the second door element 32 (FIG. 20). On further closing of the corner cabinet door 27, the coupling section 119 of the control slider slides down from the ramp 125, as a result of which the unlocking bevel 124 comes into contact with the release bevel 114 at the transition between coupling section 119 and base section 108 and ensures that the catch 109 slides down from the ratchet surface 110, as shown in FIG. 23. As a result, the locking of the control slider is released and this can be moved in the direction of its inner position 49. On further closing of the corner cabinet door 27, the coupling element 119 and coupling section 112 of the control slider are coupled with one another, whereby the tip 127 of the moveable part 126 is located in the engagement opening 113.

On subsequent opening of the corner cabinet door 27, the withdrawal surface 128 on the underside of the tip 127 comes into contact with a driving surface on the engagement opening 113, as a result of which the control slider is pulled out of the 5 receiving opening 107 when opening the door. On further opening, as from a certain opening angle of the second door element 32 the moveable part 126 is pressed back against the spring force of the spring, so that the coupling element 119 and thus the second door element 32 is uncoupled.

What is claimed is:

1. A control device for controlling the movement of a corner cabinet door of a corner cabinet which has a cabinet carcass with a door opening, said corner cabinet door being mounted on the cabinet carcass so as to swivel between a closed position in which the door opening is closed and an open position allowing access to an interior space of the cabinet carcass, wherein the corner cabinet door is designed as a folding door, with a first door element which is mounted on the cabinet carcass in the vicinity of the door opening by means of a door bearing device and with a second door element which is mounted swivelably on the first door element via swivel bearing means, with a base part which can be fixed onto the cabinet carcass and a control part which is mounted on the base part so as to be moveable between an inner position and an outer position in which it projects beyond the plane of the door opening, wherein the control part can be coupled with the second door element when closing by means of coupling means and uncoupled when opening, such that it controls the movement of the second door element at the end the closing phase and at the beginning of the opening phase.

2. The control device according to claim 1, wherein the control part is mounted on the base part so as to be swivelable around a control part swivel axis spaced at a distance from a door swivel axis.

3. The control device according to claim 1, wherein the coupling means comprise a guide groove and a guide pin interacting with this such that, on closing the second door element, the guide pin can be introduced into the guide groove and guided therein as the control part is swivelled, into its inner position, and wherein, when opening the second door element, the guide pin is held in the guide groove and guided therein as the control part is swivelled, into its outer position, and can be disengaged from the guide groove in the outer position of the control part.

4. The control device according to claim 3, wherein the guide groove is formed on the control part and the guide pin is associated with the second door element.

5. The control device according to claim 4, wherein the guide groove has a mouth section open towards an outer side of the control part facing the second door element.

6. The control device according to claim 5, wherein the guide pin forms part of a coupling element, formed separately from the second door element, associated with the control device which can be fixed detachably to the inner side of the second door element.

7. The control device according to claim 1, wherein the control part is designed in the form of a control slider which is mounted on the base part so as to be displaceable in a linear manner between the inner position and the outer position by means of guide means.

8. The control device according to claim 1, wherein locking means are provided by means of which the control part is locked in position in its outer position with uncoupled second door element, wherein the locking means are designed such that, on coupling the second door element and control part, a release of the locking takes place enabling a movement of the control part.

9. The control device according to claim 8, wherein a stop surface for the second door element, effective in the locked outer position of the control par, is formed on the control part on its outer side.

10. The control device according to claim 8, wherein the locking means have a switching element, guided on the control part so as to be moveable between a locking position assumed in the outer position of the control part with uncoupled second door element and a release position, which can be moved or switched into the release position by introducing the guide pin into the guide groove.

11. The control device according to claim 10, wherein the switching element is designed in the form of a switching slider which is adjustable in a linear manner between the locking and release positions.

12. The control device according to claim 11, wherein the switching element has a locking stop which, in the locking position, is in contact with a counter-stop formed on the base part, causing a blocking of the moveability of the control part.

13. The control device according to claim 12, wherein the counter-stop on the base part forms part of a guide contour guiding the locking stop outside of the locking position.

14. The control device according to claim 11, wherein restoring means are associated with the switching element which hold the switching element in the locking position when the second door element is uncoupled.

15. The control device according to claim 11, wherein the switching element has a notch-like engagement opening which, in the locking position of the switching element, aligns with the mouth section of the guide groove allowing engagement of the guide pin.

16. The control device according to claim 1, wherein a damping device, associated with the control part, is provided for damping the movement of the control part from the outer to the inner position.

17. The control device according to claim 16, wherein the damping device has a rotary damper, said rotary damper having a rotationally-mounted rotary piston which is associated with a gear wheel initiating the rotational movement, and wherein the control part has an arc-shaped rack segment which meshes with, or can be brought into engagement with the gear wheel.

18. A corner cabinet having a carcass with a door opening and a corner cabinet door which is mounted on the cabinet carcass so as to swivel between a closed position in which the door opening is closed and an open position allowing access to an interior space of the cabinet carcass, wherein the corner cabinet door is designed as a folding door, with a first door element which is mounted on the cabinet carcass in the vicinity of the door opening by means of a door bearing device, and with a second door element which is mounted swivelably on the first door element via swivel bearing means, and further comprising a control device according to claim 1.

19. The corner cabinet according to claim 18, wherein, in the closed position, outer sides of the two door elements pointing away from the interior space enclose an external angle α which in the closed position lies within the range from 45° to 180° and can be changed when opening the corner cabinet door, wherein a swivel angle limiting device acting between the two door elements is provided through which the swivelling range of the two door elements relative to one another is limited to a maximum external angle α which lies within the range from 45° to 180°.

20. The corner cabinet according to claim 19, wherein the maximum external angle α lies within the range from 120° to 130°.
